(19) United States
(12) Patent Application Publication
(10) Pub. No.: US 2013/0279811 A1
(43) Pub. Date: Oct. 24, 2013

(54) METHOD AND SYSTEM FOR AUTOMATICALLY SELECTING REPRESENTATIVE THUMBNAIL OF PHOTO FOLDER

(71) Applicant: Tzu-Hung Cheng, Taipei (TW)

(72) Inventor: Tzu-Hung Cheng, Taipei (TW)

(73) Assignee: Primax Electronics Ltd., Taipei (TW)

(21) Appl. No.: 13/493,277

(22) Filed: Jun. 11, 2012

(30) Foreign Application Priority Data
Apr. 20, 2012 (TW) 101114174

(51) Int. Cl. G06K 9/62

(52) U.S. Cl. 382/195

(57) ABSTRACT

A method for automatically selecting a representative thumbnail of a photo folder is provided. Firstly, a face detecting step is performed for judging whether plural photo images in the photo folder contain at least one face image. If the at least one face image in the plural photo images is detected, a face recognizing step is performed to acquire at least one facial feature. Then, the facial feature having the highest occurrence number is selected as a target facial feature. Then, the plural photo images including the target facial feature are rated to acquire plural scores. Afterwards, the photo image with the highest score is assigned as the representative thumbnail of the photo folder.

### FIELD OF THE INVENTION

The present invention relates to a method for automatically selecting a representative thumbnail of a photo folder, and more particularly to a method for automatically selecting a representative thumbnail of a photo folder according to the user's preferences.

### BACKGROUND OF THE INVENTION

Image pickup devices are usually employed to take photos. Conventionally, the image pickup devices are film cameras. With the advent of the digitalized generation, the image pickup devices are gradually developed as digital cameras or video camera. In addition to the function of taking photos, the digitalized image pickup devices also have the photographic function of recording dynamic movies. The photos or movies acquired by an image pickup device may be stored in an electronic device (e.g. a computer) in the form of electronic files. The images of the photos and the movies may be watched by the user through the electronic device, and the favorite images may be selected and outputted as the conventional photos.

With increasing development of science and technology, image pickup devices become essential components of electronic devices (e.g. mobile phones, notebook computers and tablet personal computers). Among theses electronic devices, smart phones and tablet personal computers are more advantageous because of their portability. Consequently, almost all of the smart phones and the tablet personal computers are equipped with image pickup devices for facilitating the users to take photos.

Moreover, since the image pickup devices are digitalized, it is important to manage the electronic files of the photo images and the movie images. Generally, the photo images or the movie images captured by an image pickup device are transmitted to a computer host. Under execution of an operating system in the computer host, a photo folder may be created to contain the photo images or the movie images.

Please refer to FIGS. 1 and 2. FIG. 1 schematically illustrates a window showing plural photo image of a photo folder according to the prior art. FIG. 2 schematically illustrates a representative thumbnail of the photo folder of FIG. 1. As shown in FIG. 1, the window 1 is a user operation interface. Through the window 1, plural photo images 101 contained in a photo folder 10 may be viewed by the user. As known, although these photo images 101 are shown on the window 1, these photo images 101 are not stored in the window 1. Whereas, these photo images 101 are stored in a computer system (not shown).

As shown in FIG. 2, the photo folder 10 is displayed on the window 1. The photo folder 10 contains the plural photo images 101. By clicking the photo folder 10 that is displayed on the window 1, the photo folder 10 is opened, and thus the photo images 101 contained in the photo folder 10 are viewable (see FIG. 1). After the browsing page is backward to the previous page, the photo folder 10 is displayed on the window 1. Moreover, some photo images 101 of the photo folder 10, which are denoted as plural representative thumbnails P, are displayed on the window 1. By viewing the representative thumbnails P of the photo images 101, the user can recognize the facial images or the landscape images of the photo images 101.

Since the photo folder 10 usually contains a large number of photo images 101, the computer system may randomly select some photo images 101 from the photo folder 10 as the representative thumbnails P of the photo folder 10. For example, the computer system may preset four representative thumbnails P of each photo folder 10. That is, four representative thumbnails P are displayed on the icon of the photo folder 10 (see FIG. 2).

Please refer to FIG. 2. Since the area of the photo folder 10 displayed on the window 1 of the computer system is very small, the four representative thumbnails P are relatively smaller. Under this circumstance, the user fails to clearly recognize the contents of these four representative thumbnails P by the naked eyes. For enlarging the representative thumbnail P, some computer systems may select a first one of the photo images as the preset representative thumbnail, or some computer systems may select the newest one of the photo images as the preset representative thumbnail. Since only a single representative thumbnail is displayed on the photo folder, the size of the representative thumbnail becomes larger, and the contents thereof are easily recognized by the user. However, the first photo image of the photo folder or the newest photo image of the photo folder does not always meet the user's preferences. That is, the user is possibly unwilling to accept the preset representative thumbnail.

For meeting the user's preferences, the user may select a desired photo image from the photo folder 10 of the computer system as the representative thumbnail, and the representative thumbnail is displayed on the icon of the photo folder 10 alone. However, since the user needs to personally view the photo images 101 of the photo folder 10 and select one of the abundant photo images 101 as the representative thumbnail, this approach is time-consuming and labor-intensive.

Therefore, there is a need of providing an improved a method for automatically selecting a representative thumbnail of a photo folder without the manual selection.

### SUMMARY OF THE INVENTION

The present invention provides a method for automatically selecting a representative thumbnail of a photo folder without the manual selection.

In accordance with a first aspect of the present invention, there is provided an automatic thumbnail selecting method for automatically selecting a representative thumbnail of a photo folder. The automatic thumbnail selecting method includes the following steps. Firstly, a face detecting step is performed for judging whether there is at least one face image contained in plural photo images of the photo folder. If the at least one face image in the plural photo images is detected by the face detecting step, a face recognizing step is performed. The face recognizing step includes sub-steps of performing a face recognizing operation on the plural photo images to acquire at least one facial feature, calculating an occurrence number of the at least one facial feature in the plural photo images, selecting the facial feature having the highest occurrence number as a target facial feature, rating the plural photo images including the target facial feature to acquire plural scores, and compare the plural scores with each other to acquire a highest score. If no face image in the plural photo images is detected by the face detecting step, a complexity analyzing step is performed. The complexity analyzing step includes sub-steps of performing a complexity analyzing operation on the plural photo images to acquire plural complexity values, and comparing the plural complexity values with each other to acquire the highest complexity value. After the face detecting step is performed, a selecting step is performed for selecting the photo image with the highest score as the representative thumbnail of the photo folder. Alternatively, after the complexity analyzing step is performed, the selecting step is performed for selecting the photo image with the highest complexity value as the representative thumbnail of the photo folder.

In an embodiment, the selecting step further includes sub-steps of capturing the face image contained in the photo image with the highest score, and assigning the captured face image as the representative thumbnail of the photo folder.

In an embodiment, if the photo image with the highest score contains a first face image and a second face image, the automatic thumbnail selecting method further includes steps of comparing whether the target facial feature matches the facial feature corresponding to the first face image or the facial feature corresponding to the second face image, and assigning the first face image or the second face image matching the target facial feature as the representative thumbnail of the photo folder.

In an embodiment, the selecting step further includes sub-steps of capturing a middle zone contained in the photo image with the highest complexity value as a middle zone image, and assigning the middle zone image as the representative thumbnail of the photo folder.

In an embodiment, the plural photo images are rated according to plural rating items, wherein the plural rating items include a facial organ item, a facial skin color item, a facial angle item, a facial size item, and a facial expression item.

In an embodiment, the score of the facial organ item is determined according to an organ number of the at least one facial feature and an organ shape completeness degree, the core of the facial skin color item is determined according to a tone of the at least one facial feature, the score of the facial angle item is determined according to a facial direction of the at least one facial feature, the score of the facial size item is determined according to a face size of the at least one facial feature in the at least one photo image, and the score of the facial expression item is determined by judging whether a mouse corner of the at least one facial feature is upturned or not.

In an embodiment, the complexity analyzing operation is performed to analyze entropy of each of the plural photo images.

In accordance with a second aspect of the present invention, there is provided an automatic thumbnail selecting system for automatically selecting a representative thumbnail of a photo folder. The automatic thumbnail selecting system is installed in a computer system with a storage unit and a controlling unit. The storage unit is used for storing the photo folder and plural photo images. The controlling unit is in communication with the storage unit for selecting the representative thumbnail of the photo folder. The automatic thumbnail selecting system includes a face detecting module, an image analyzing module, a statistic module, and a rating module. The face detecting module is in communication with the controlling unit for issuing a detecting signal to the controlling unit. In response to the detecting signal, the controlling unit detects plural photo images contained in the photo folder, thereby acquiring at least one face image corresponding to the plural photo images. The image analyzing module is in communication with the controlling unit for issuing a recognizing signal or an analyzing signal to the controlling unit. In response to the recognizing signal, the controlling unit recognizes the at least one face image, thereby acquiring at least one facial feature corresponding to the at least one face image. In response to the analyzing signal, the controlling unit analyzes complexity of the plural photo images, thereby acquiring plural complexity values corresponding to the plural photo images. The statistic module is in communication with the controlling unit for issuing a statistic signal to the controlling unit. In response to the statistic signal, the controlling unit calculates an occurrence number of the at least one facial feature in the plural photo images, and selects the facial feature having the highest occurrence number as a target facial feature. The rating module is in communication with the controlling unit for issuing a first rating signal or a second rating signal to the controlling unit. In response to the first rating signal, the controlling module rates the plural photo images including the target facial feature to acquire plural scores, compares the plural scores with each other to acquire a highest score of the plural scores, and assigns the photo image with the highest score as the representative thumbnail of the photo folder. In response to the second rating signal, the controlling module compares the plural complexity values with each other to acquire the highest complexity value, and assigns the photo image with the highest complexity value as the representative thumbnail of the photo folder.

In an embodiment, when the controlling unit assigns the photo image with the highest score as the representative thumbnail of the photo folder, the image analyzing module issues a capturing signal to the controlling unit. In response to the capturing signal, the controlling unit captures a face image contained in the photo image with the highest score, and assigns the captured face image as the representative thumbnail of the photo folder.

In an embodiment, if the photo image with the highest score contains a first face image and a second face image, the image analyzing module issues a comparing signal to the controlling unit. In response to the comparing signal, the controlling unit compares whether the target facial feature matches the facial feature corresponding to the first face image or the facial feature corresponding to the second face image, and assigns the first face image or the second face image matching the target facial feature as the representative thumbnail of the photo folder.

In an embodiment, when the controlling unit assigns the photo image with the highest complexity value as the representative thumbnail of the photo folder, the image analyzing module issues a capturing signal to the controlling unit. In response to the capturing signal, the controlling unit captures a middle zone contained in the photo image with the highest complexity value as a middle zone image, and assigns the middle zone image as the representative thumbnail of the photo folder.

In an embodiment, the rating module provides plural rating items, and the plural photo images including the target facial feature are rated by the controlling unit according to the plural rating items. The plural rating items include a facial organ item, a facial skin color item, a facial angle item, a facial size item, and a facial expression item, wherein the plural rating items are set through a user operation interface.

In an embodiment, the score of the facial organ item is determined according to an organ number of the at least one facial feature and an organ shape completeness degree, the core of the facial skin color item is determined according to a tone of the at least one facial feature, the score of the facial angle item is determined according to a facial direction of the at least one facial feature, the score of the facial size item is determined according to a face size of the at least one facial feature in the at least one photo image, and the score of the facial expression item is determined by judging whether a mouse corner of the at least one facial feature is upturned or not.

In an embodiment, the computer system further includes a display screen for displaying the photo folder, the plural photo images and the representative thumbnail, the storage unit is a hard disc, and the controlling unit is a central processing unit.

In accordance with a third aspect of the present invention, there is provided an automatic thumbnail selecting method for automatically selecting a representative thumbnail of a photo folder. The automatic thumbnail selecting method includes the following steps. Firstly, a face detecting step is performed for detecting plural photo images in the photo folder, thereby acquiring at least one face image. Then, a face recognizing step is performed. The face recognizing step includes sub-steps of performing a face recognizing operation on the plural photo images to acquire at least one facial feature, calculating an occurrence number of the at least one facial feature in the plural photo images, selecting the facial feature having the highest occurrence number as a target facial feature, rating the plural photo images including the target facial feature to acquire plural scores, and comparing the plural scores with each other to acquire a highest score. Afterwards, a selecting step is performed for selecting the photo image with the highest score as the representative thumbnail of the photo folder.

In an embodiment, the selecting step further includes sub-steps of capturing the face image contained in the photo image with the highest score, and assigning the captured face image as the representative thumbnail of the photo folder.

In an embodiment, if the photo image with the highest score contains a first face image and a second face image, the automatic thumbnail selecting method further includes steps of comparing whether the target facial feature matches the facial feature corresponding to the first face image or the facial feature corresponding to the second face image, and assigning the first face image or the second face image matching the target facial feature as the representative thumbnail of the photo folder.

In an embodiment, the plural photo images are rated according to plural rating items, wherein the plural rating items include a facial organ item, a facial skin color item, a facial angle item, a facial size item, and a facial expression item.

In an embodiment, the score of the facial organ item is determined according to an organ number of the at least one facial feature and an organ shape completeness degree, the core of the facial skin color item is determined according to a tone of the at least one facial feature, the score of the facial angle item is determined according to a facial direction of the at least one facial feature, the score of the facial size item is determined according to a face size of the at least one facial feature in the at least one photo image, and the score of the facial expression item is determined by judging whether a mouse corner of the at least one facial feature is upturned or not.

In accordance with a fourth aspect of the present invention, there is provided an automatic thumbnail selecting method for automatically selecting a representative thumbnail of a photo folder. The automatic thumbnail selecting method includes the following steps. Firstly, a face detecting step for detecting plural photo images in the photo folder, wherein no face image in the plural photo images is detected by the face detecting step. Then, a complexity analyzing step is performed. The complexity analyzing step includes sub-steps of performing a complexity analyzing operation on the plural photo images to acquire plural complexity values, and compares the plural complexity values with each other to acquire the highest complexity value. Afterwards, a selecting step is performed for selecting the photo image with the highest complexity value as the representative thumbnail of the photo folder.

In an embodiment, the selecting step further includes sub-steps of capturing a middle zone contained in the photo image with the highest complexity value as a middle zone image, and assigning the middle zone image as the representative thumbnail of the photo folder.

In an embodiment, the complexity analyzing operation is performed to analyze entropy of each of the plural photo images.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a window showing plural photo image of a photo folder according to the prior art;

FIG. 2 schematically illustrates a representative thumbnail of the photo folder of FIG. 1;

FIG. 3 is a flowchart illustrating a method for automatically selecting a representative thumbnail of a photo folder according to an embodiment of the present invention;

FIG. 4 is a schematic block diagram illustrating a system for automatically selecting a representative thumbnail of a photo folder according to a first embodiment of the present invention;

FIG. 5 schematically illustrates a window showing plural photo image of a photo folder by the automatic thumbnail selecting system of FIG. 4;

FIG. 6 schematically illustrates a way of recognizing the face image of the photo images of the photo folder and calculating the occurrence number of each facial feature by the automatic thumbnail selecting system of FIG. 4;

FIG. 7 schematically illustrates a user operation interface used in the automatic thumbnail selecting system of FIG. 4;

FIG. 8 schematically illustrates a representative thumbnail of a photo folder selected by the automatic thumbnail selecting system of FIG. 4;

FIG. 9 is a schematic block diagram illustrating a system for automatically selecting a representative thumbnail of a photo folder according to a second embodiment of the present invention;

FIG. 10 schematically illustrates a window showing plural photo image of a photo folder by the automatic thumbnail selecting system of FIG. 9; and

FIG. 11 schematically illustrates a representative thumbnail of a photo folder selected by the automatic thumbnail selecting system of FIG. 9.

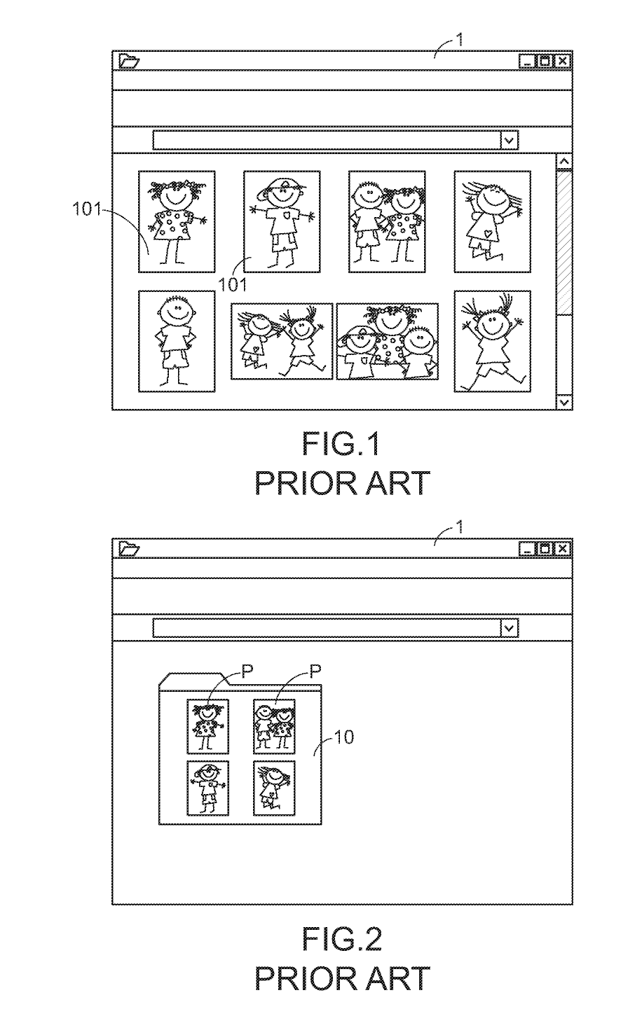

### DETAILED DESCRIPTION OF THE PREFERRED EMBODIMENT

For eliminating the drawbacks encountered from the prior art, the present invention provides a method for automatically selecting a representative thumbnail of a photo folder and a system for automatically selecting a representative thumbnail of a photo folder.

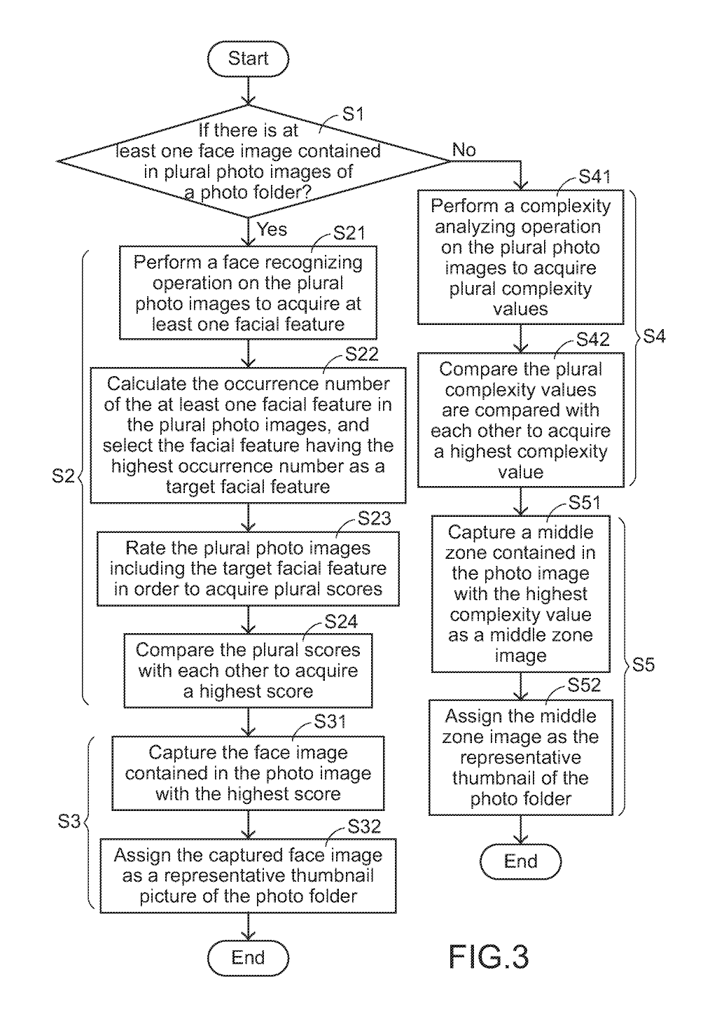

FIG. 3 is a flowchart illustrating a method for automatically selecting a representative thumbnail of a photo folder according to an embodiment of the present invention. In this context, the method for automatically selecting the representative thumbnail of the photo folder is also referred as an automatic thumbnail selecting method. In accordance with the present invention, a first exemplary automatic thumbnail selecting method comprises a face detecting step S1, a face recognizing step S2, and a selecting step S3. The face detecting step S1 is performed to judge whether there is at least one face image contained in plural photo images of a photo folder. The selecting step S3 is performed to select a specified photo image as a representative thumbnail according to the results of the face recognizing step S2. The face recognizing step S2 includes the sub-steps S21, S22, S23, and S24. In the sub-step S21, a face recognizing operation is performed on the plural photo images, thereby acquiring at least one corresponding facial feature. In the step S22, the occurrence number of the at least one facial feature in the plural photo images is calculated, and the facial feature having the highest occurrence number is selected as a target facial feature. In the sub-step S23, the plural photo images 212 including the target facial feature are rated, and plural corresponding scores are acquired. In the sub-step S24, the plural scores are compared with each other, so that the highest score is acquired. The selecting step S3 includes the sub-steps S31 and S32. In the sub-step S31, the face image contained in the photo image with the highest score is captured. In the sub-step S32, the captured face image is assigned as the representative thumbnail of the photo folder.

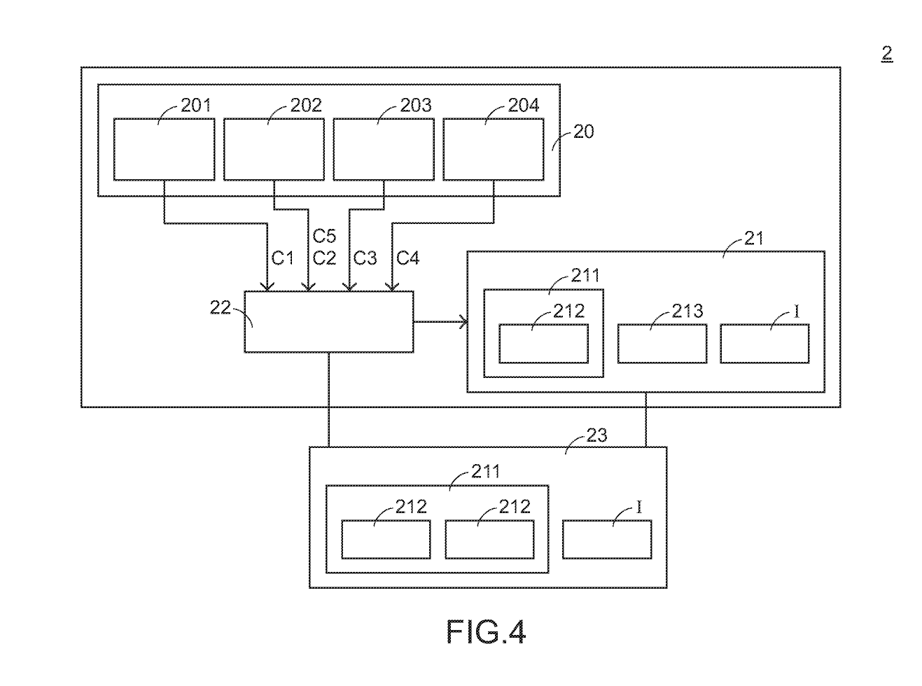

FIG. 4 is a schematic block diagram illustrating a system for automatically selecting a representative thumbnail of a photo folder according to a first embodiment of the present invention. In this context, the system for automatically selecting the representative thumbnail of the photo folder is referred as an automatic thumbnail selecting system. As shown in FIG. 4, a computer system 2 comprises an automatic thumbnail selecting system 20, a storage unit 21, a controlling unit 22, and a display screen 23. The storage unit 21 is in communication with the controlling unit 22 for storing a photo folder 211 and plural photo images 212. The plural photo images 212 are contained in the photo folder 211. The display screen 23 is in communication with the storage unit 21 and the controlling unit 22 for displaying the photo folder 211, the plural photo images 212 and a representative thumbnail I. The automatic thumbnail selecting system 20 is in communication with the controlling unit 22. Moreover, the automatic thumbnail selecting system 20 comprises a face detecting module 201, an image analyzing module 202, a statistic module 203, and a rating module 204. In an embodiment, the computer system 2 is a notebook computer, the automatic thumbnail selecting system 20 is an application program installed in the computer system 2, the storage unit 21 is a hard disc, and the controlling unit 22 is a central processing unit. In some embodiments, the computer system is a desktop computer, a smart phone, a tablet personal computer, or the like.

In the automatic thumbnail selecting system 20, the face detecting module 201 is in communication with the controlling unit 22 for issuing a detecting signal C1 to the controlling unit 22. In response to the detecting signal C1, the controlling unit 22 detects wherein there is any face image contained in the plural photo images 212 of the photo folder 211. In a case that at least one face image 213 of the plural photo images 212 is detected by the controlling unit 22, the at least one face image 213 of the plural photo images 212 is acquired. The image analyzing module 202 is in communication with the controlling unit 22 for issuing a recognizing signal C2 to the controlling unit 22. In response to the recognizing signal C2, the controlling unit 22 recognizes the at least one face image 213, and acquires at least one facial feature corresponding to the at least one face image 213. The statistic module 203 is in communication with the controlling unit 22 for issuing a statistic signal C3 to the controlling unit 22. In response to the statistic signal C3, the controlling unit 22 calculates the occurrence number of the at least one facial feature in the plural photo images 212, and selects a facial feature having the highest occurrence number as a target facial feature. The rating module 204 is in communication with the controlling unit 22 for issuing a rating signal C4 to the controlling unit 22. In response to the rating signal C4, the controlling unit 22 rates the plural photo images 212 of the photo folder 211 including the target facial feature, thereby acquiring plural corresponding scores. By comparing these scores with each other, the controlling unit 22 may assign the photo image 212 with the highest score of these scores as the representative thumbnail I of the photo folder 211.

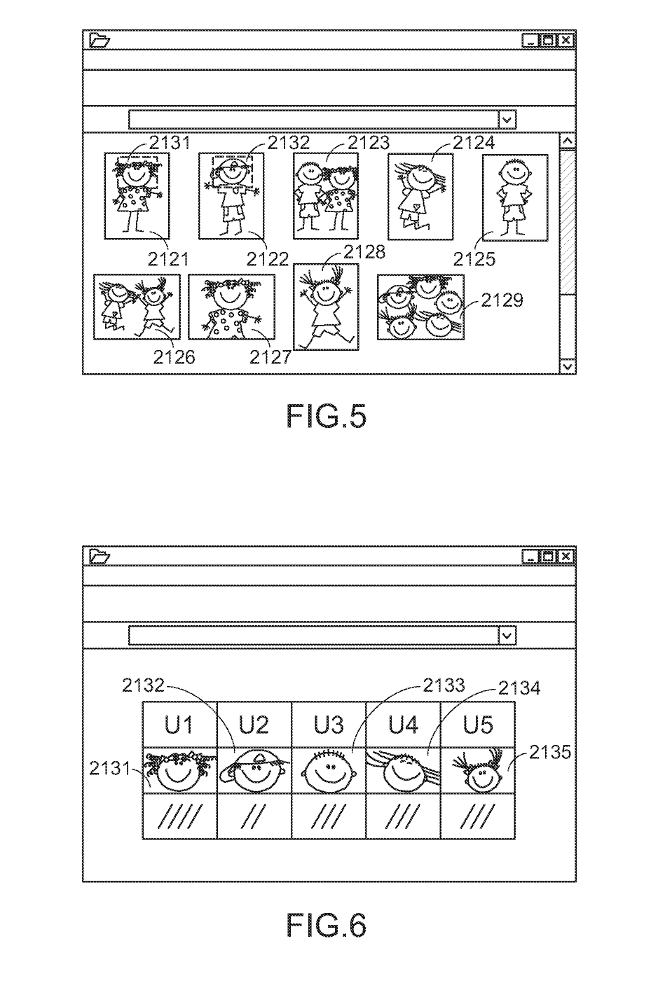

The operations of the automatic thumbnail selecting system 20 will be illustrated in more details as follows. FIG. 5 schematically illustrates a window showing plural photo image of a photo folder by the automatic thumbnail selecting system of FIG. 4. After the automatic thumbnail selecting system 20 is enabled, the user may select the photo folder 211. Consequently, the automatic thumbnail selecting system 20 will automatically select a representative thumbnail from the plural photo images 212 of the photo folder 211. In FIG. 5, the plural photo images 212 are shown. The plural photo images 212 include a first photo image 2121, a second photo image 2122, a third photo image 2123, a fourth photo image 2124, a fifth photo image 2125, a sixth photo image 2126, a seventh photo image 2127, an eighth photo image 2128, and a ninth photo image 2129.

FIG. 6 schematically illustrates a way of recognizing the face image of the photo images of the photo folder and calculating the occurrence number of each facial feature by the automatic thumbnail selecting system of FIG. 4. Firstly, the face detecting module 201 issues a detecting signal C1 to the controlling unit 22. In response to the detecting signal C1, the controlling unit 22 detects the plural photo images 212 of the photo folder 211 (see the face detecting step S1 as shown in FIG. 3). After the face detecting step S1 is performed, the locations of plural face image 213 of the plural photo images 212 are acquired. The plural face image 213 comprises a first face image 2131, a second face image 2132, a third face image 2133, a fourth face image 2134, and a fifth face image 2135. The first face image 2131 is the face image of a first user U1. The second face image 2132 is the face image of a second user U2. The third face image 2133 is the face image of a third user U3. The fourth face image 2134 is the face image of a fourth user U4. The fifth face image 2135 is the face image of a fifth user U5.

After the plural face images 213 are acquired, the image analyzing module 202 issues a recognizing signal C2 to the controlling unit 22. In response to the recognizing signal C2, the controlling unit 22 recognizes all of the face images 213 of the photo folders 211, and acquires corresponding facial features (see the sub-step S21 of the face recognizing step S2 as shown in FIG. 3).

Please refer to FIGS. 5 and 6 again. The first photo image 2121 contains the facial feature corresponding to the first face image 2131. That is, the first photo image 2121 has the facial feature of the first user U1. The second photo image 2122 contains the facial feature corresponding to the second face image 2132. That is, the second photo image 2122 has the facial feature of the second user U2. The third photo image 2123 contains the facial feature corresponding to the first face image 2131 and the facial feature corresponding to the third face image 2133. That is, the third photo image 2123 has the facial features of the first user U1 and the third user U3. The fourth photo image 2124 contains the facial feature corresponding to the fourth face image 2134. That is, the fourth photo image 2124 has the facial feature of the fourth user U4. The fifth photo image 2125 contains the facial feature corresponding to the third face image 2133. That is, the fifth photo image 2125 has the facial feature of the third user U3. The sixth photo image 2126 contains the facial feature corresponding to the fourth face image 2134 and the facial feature corresponding to the fifth face image 2135. That is, the sixth photo image 2126 has the facial features of the fourth user U4 and the fifth user U5. The seventh photo image 2127 contains the facial feature corresponding to the first face image 2131. That is, the seventh photo image 2127 has the facial feature of the first user U1. The eighth photo image 2128 contains the facial feature corresponding to the fifth face image 2135. That is, the eighth photo image 2128 has the facial feature of the fifth user U5. The ninth photo image 2129 contains the facial features corresponding to the first face image 2131, the second face image 2132, the third face image 2133, the fourth face image 2134 and the fifth face image 2135. That is, the ninth photo image 2129 has the facial features of the first user U1, the second user U2, the third user U3, the fourth user U4 and the fifth user U5.

After all of the facial features are recognized, the statistic module 203 issues a statistic signal C3 to the controlling unit 22. In response to the statistic signal C3, the controlling unit 22 calculates the occurrence number of each facial feature in the plural photo images 212, and selects the facial feature having the highest occurrence number as a target facial feature (see the sub-step S22 of the face recognizing step S2 as shown in FIG. 3). Please refer to FIG. 6 again. According to the statistic result obtained by the controlling unit 22, the occurrence number of the facial feature corresponding to the first face image 2131 in the plural photo images 212 is 4. In addition, the occurrence number of the facial feature corresponding to the second face image 2132 in the plural photo images 212 is 2. The occurrence number of the facial feature corresponding to the third face image 2133 in the plural photo images 212 is 3. The occurrence number of the facial feature corresponding to the fourth face image 2134 in the plural photo images 212 is 3. The occurrence number of the facial feature corresponding to the fifth face image 2135 in the plural photo images 212 is 3. Since the controlling unit 22 judges that the facial feature of the first user U1 has the highest occurrence number among the plural photo images 212 of the photo folder 211, the controlling unit 22 will select the facial feature corresponding to the first face image 2131 as a target facial feature in order to further determine the representative thumbnail.

Then, the rating module 204 issues a rating signal C4 to the controlling unit 22. In response to the rating signal C4, the controlling unit 22 rates the plural photo images 212 of the photo folder 211 including the target facial feature (i.e. the facial feature corresponding to the first face image 2131), thereby acquiring plural corresponding scores (see the sub-step S23 of the face recognizing step S2 of FIG. 3). Then, by comparing these scores with each other, the controlling unit 22 acquires the highest score (see the sub-step S24 of the face recognizing step S2 of FIG. 3). In this embodiment, the rating module 204 provides plural rating items. According to the plural rating items, the plural photo images 212 including the target facial feature are rated by the controlling unit 22. In addition, the plural rating items may be set through a user operation interface 2111.

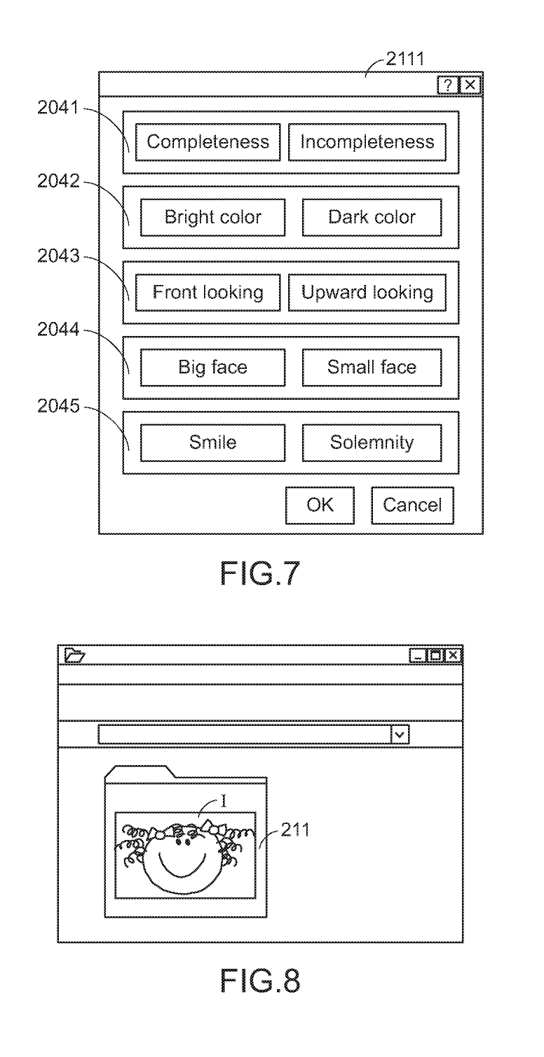

FIG. 7 schematically illustrates a user operation interface used in the automatic thumbnail selecting system of FIG. 4. By clicking a window selecting item of the photo folder 211, the user operation interface 2111 may be opened. The plural rating items provided by the user operation interface 2111 includes a facial organ item 2041, a facial skin color item 2042, a facial angle item 2043, a facial size item 2044, and a facial expression item 2045. In the facial organ item 2041, the score is determined according to the organ number of the facial feature and the organ shape completeness degree. Of course, the scoring datum of the facial organ item 2041 may be set or changed according to the user's preferences. For example, if the score is determined according to the organ number of the facial feature and the organ shape completeness degree, the photo image showing the complete facial organs has the high score. Alternatively, if the score is determined according to the organ number of the facial feature and the organ shape incompleteness degree, the photo image showing only local facial organs has the high score. In the facial skin color item 2042, the score is determined according to the tone of the facial feature. For example, if the tone of the facial feature is bright color-oriented, the photo image showing the bright tone of the facial feature has the high score. Alternatively, if the tone of the facial feature is dark color-oriented, the photo image showing the dark tone of the facial feature has the high score.

In the facial angle item 2043, the score is determined according to the facial direction of the facial feature. For example, if the facial direction is front looking status-oriented, the image showing the front looking status of the facial feature has the high score. Alternatively, if the facial direction is upward looking status-oriented, the image showing the upward looking status of the facial feature has the high score. In the facial size item 2044, the score is determined according to the face size of the facial feature in the photo image 212. For example, if the face size of the facial feature is big size-oriented, the photo image showing the face fraction higher than 50% has the high score. Alternatively, if the face size of the facial feature is small size-oriented, the photo image showing the face fraction lower than 50% has the high score. In the facial expression item 2045, the score is determined according to the mouse corner status of the facial image. For example, if the facial expression of the facial feature is smile-oriented, the photo image showing the upturned mouth corners of the facial feature has the high score. Alternatively, if the facial expression of the facial feature is solemnity-oriented, the photo image with no upturned mouth corners of the facial feature has the high score.

In a preferred embodiment, the score of the facial organ item 2041 is determined according to the organ number of the facial feature and the organ shape completeness degree, the score of the facial skin color item 2042 is determined according to the bright color-oriented facial feature, the score of the facial angle item 2043 is determined according to the front looking status-oriented facial feature, the score of the facial size item 2044 is determined according to a small face size-oriented facial feature, and the score of the facial expression item 2045 is determined according to the smile-oriented facial feature. According to this judging datum, the controlling unit 22 may judge that the first photo image 2121 containing the first face image 2131 has the highest score.

Then, the controlling unit 22 assigns the photo image 212 with the highest score as the representative thumbnail I of the photo folder 211. At the same time, the image analyzing module 202 issues a capturing signal C5 to the controlling unit 22. In response to the capturing signal C5, the face image 213 contained in the photo image 212 with the highest score is captured by the controlling unit 22 (see the sub-step S31 of the selecting step S3). Then, the controlling unit 22 assigns the captured face image 213 as the representative thumbnail I of the photo folder 211 (see the sub-step S32 of the selecting step S3). That is, by the controlling unit 22, the first face image 2131 of the first photo image 2121 is captured, and the first face image 2131 is assigned as the representative thumbnail I. Moreover, the representative thumbnail I is displayed on the photo folder 211 alone (see FIG. 8). Meanwhile, the automatic thumbnail selecting method is terminated.

In some embodiments, the controlling unit 22 may judge that the face image 213 corresponding to the target facial feature is the first face image 2131 and the photo image 212 with the highest score is the third photo image 2123 according to the plural rating items. Since the third photo image 2123 contains the first face image 2131 and the third face image 2133, the controlling unit 22 fails to directly assign one of the first face image 2131 and the third face image 2133 as the representative thumbnail. Meanwhile, the image analyzing module 202 issues a comparing signal C6 to the controlling unit 22. In response to the comparing signal C6, the controlling unit 22 will compare whether the target facial feature matches the facial feature corresponding to the first face image 2131 or the facial feature corresponding to the third face image 2133. According to the comparing result, the controlling unit 22 realizes that the target facial feature matches the facial feature corresponding to the first face image 2131. Consequently, the first face image 2131 matching the target facial feature is assigned as the representative thumbnail I by the controlling unit 22.

From the above discussions, the method and the system for automatically selecting a representative thumbnail of a photo folder may be implemented according to the user's preferences. As a consequence, a photo image meeting the user's preferences may be selected as the representative thumbnail of the photo folder.

The present invention further provides a second exemplary automatic thumbnail selecting method. Please refer to FIG. 3 again. The second exemplary automatic thumbnail selecting method comprises a face detecting step S1, a complexity analyzing step S4, and another selecting step S5. The face detecting step S1 is performed to judge whether there is at least one face image contained in plural photo images of a photo folder. The complexity analyzing step S4 the sub-steps S41 and S42. In the sub-step S41, a complexity analyzing operation is performed on the plural photo images, thereby acquiring plural complexity values. In the sub-step S42, the plural complexity values are compared with each other, so that the highest complexity value is acquired. The selecting step S5 is performed to select a specified photo image as a representative thumbnail according to the results of the complexity analyzing step S4. The selecting step S5 includes the sub-steps S51 and S52. In the sub-step S51, the middle zone contained in the photo image with the highest complexity value is captured as a middle zone image. In the sub-step S52, the middle zone image is assigned as the representative thumbnail of the photo folder.

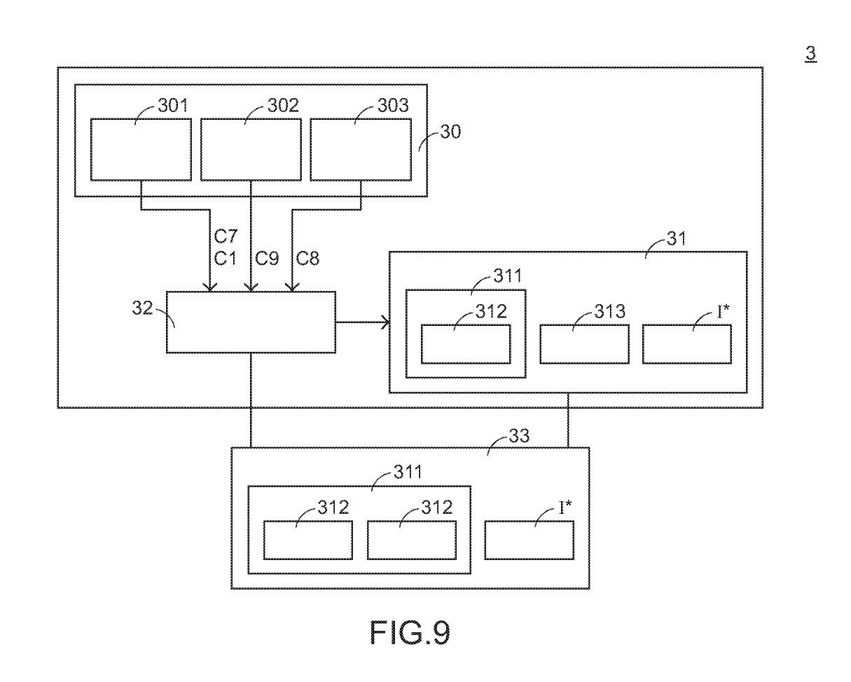

FIG. 9 is a schematic block diagram illustrating a system for automatically selecting a representative thumbnail of a photo folder according to a second embodiment of the present invention. As shown in FIG. 9, a computer system 3 comprises an automatic thumbnail selecting system 30, a storage unit 31, a controlling unit 32, and a display screen 33. The storage unit 31 is in communication with the controlling unit 32 for storing a photo folder 311 and plural photo images 312. The plural photo images 312 are contained in the photo folder 311. The display screen 33 is in communication with the storage unit 31 and the controlling unit 32 for displaying the photo folder 311, the plural photo images 312 and a representative thumbnail I*. The automatic thumbnail selecting system 30 is in communication with the controlling unit 32. Moreover, the automatic thumbnail selecting system 30 comprises a face detecting module 301, an image analyzing module 302, and a statistic module 303. In an embodiment, the computer system 3 is a desktop computer, the automatic thumbnail selecting system 30 is an application program installed in the computer system 3, the storage unit 31 is a hard disc, and the controlling unit 32 is a central processing unit. In some embodiments, the computer system is a notebook computer, a smart phone, a tablet personal computer, or the like.

In the automatic thumbnail selecting system 30, the face detecting module 301 is in communication with the controlling unit 32 for issuing a detecting signal C1 to the controlling unit 32. In response to the detecting signal C1, the controlling unit 32 detects wherein there is any face image contained in the plural photo images 312 of the photo folder 311. The image analyzing module 302 is in communication with the controlling unit 32. In a case that no face image in the plural photo images 312 is detected by the controlling unit 32, the image analyzing module 302 issues an analyzing signal C7 to the controlling unit 32. In response to the analyzing signal C7, the controlling unit 32 performs a complexity analyzing operation on the plural photo images 312, thereby acquiring plural complexity values. The statistic module 303 is in communication with the controlling unit 32 for issuing another statistic signal C8 to the controlling unit 32. In response to the statistic signal C8, the controlling unit 32 compares the plural complexity values with each other to acquire the highest complexity value, and assigns the photo image 312 with the highest complexity value as the representative thumbnail I* of the photo folder 311.

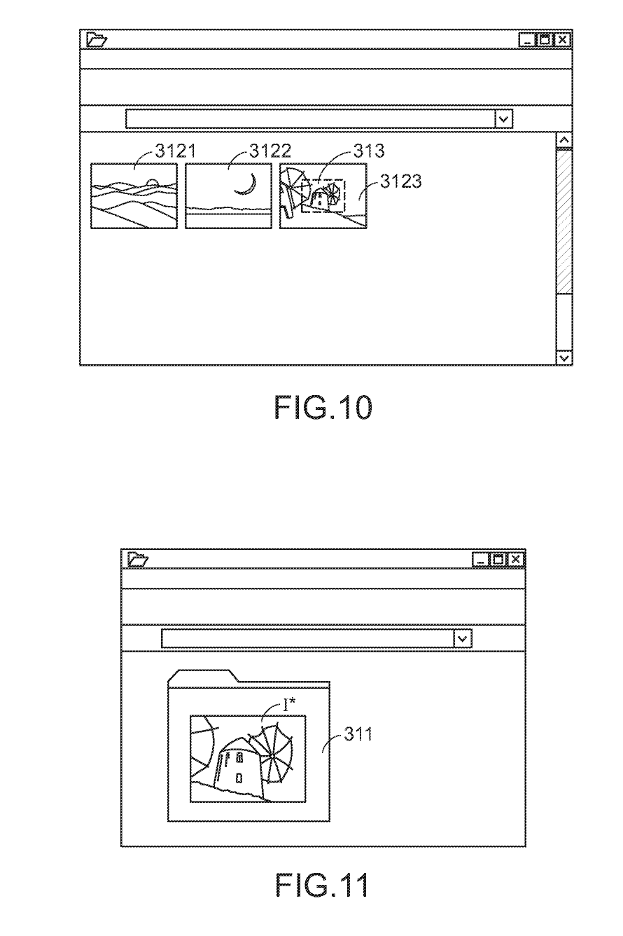

The operations of the automatic thumbnail selecting system 30 will be illustrated in more details as follows. FIG. 10 schematically illustrates a window showing plural photo image of a photo folder by the automatic thumbnail selecting system of FIG. 9. After the automatic thumbnail selecting system 30 is enabled, the automatic thumbnail selecting system 30 will automatically select a representative thumbnail from the plural photo images 312 of a specified photo folder (i.e. the photo folder 311). In FIG. 10, the plural photo images 312 are shown. The plural photo images 312 include a first photo image 3121, a second photo image 3122, and a third photo image 3123.

Firstly, the face detecting module 301 issues a detecting signal C1 to the controlling unit 32. In response to the detecting signal C1, the controlling unit 32 detects the plural photo images 312 of the photo folder 311 (see the face detecting step S1 as shown in FIG. 3). By the face detecting step S1, the controlling unit 32 realizes that no face image is contained in the plural photo images 312. It means that the plural photo images 312 are landscape images, building images, object images, or the like. Consequently, the image analyzing module 302 issues an analyzing signal C7 to the controlling unit 32. In response to the analyzing signal C7, the controlling unit 32 performs a complexity analyzing operation on the plural photo images 312, thereby acquiring plural complexity values (see the sub-steps S41 of the complexity analyzing step S4 as shown in FIG. 3). In an embodiment, the complexity analyzing operation is performed to analyze entropy of each of the plural photo images 312 by the controlling unit 32. As the entropy of the photo image 312 is increased, the complexity value of the photo image 312 is increased. Whereas, as the entropy of the photo image 312 is decreased, the complexity value of the photo image 312 is decreased.

Alternatively, in some other embodiments, the complexity analyzing operation is performed to analyze the high-frequency data number of each photo image by the controlling unit. As the high-frequency data number of the photo image is increased, the complexity value of the photo image is increased. Whereas, as the high-frequency data number of the photo image is decreased, the complexity value of the photo image is decreased.

Then, the statistic module 303 issues another statistic signal C8 to the controlling unit 32. In response to the statistic signal C8, the controlling unit 32 compares the plural complexity values (i.e. plural entropy values) with each other to acquire the highest complexity value (see the sub-steps S42 of the complexity analyzing step S4 as shown in FIG. 3). As shown in FIG. 10, the controlling unit 32 judges that the third photo image 3123 has the highest complexity value. Then, the image analyzing module 302 issues another capturing signal C9 to the controlling unit 32. In response to the capturing signal C10, a middle zone of the photo image 312 with the highest complexity value (i.e. the third photo image 3123) is captured as a middle zone image 313 by the controlling unit 32. Afterwards, the middle zone image 313 is assigned as the representative thumbnail I* of the photo folder 311 (see FIG. 11).

From the above discussions, if no face image is contained in the plural photo images, the automatic thumbnail selecting method and the automatic thumbnail selecting system of the present invention may perform a complexity analyzing operation. Since the photo image with the highest complexity value usually has the highest importance, the photo image with the highest complexity value is selected as the representative thumbnail of the photo folder.

It is noted that the above two embodiments of the automatic thumbnail selecting method and the automatic thumbnail selecting system of the present invention may be combined together. Consequently, the automatic thumbnail selecting method and the automatic thumbnail selecting system of the present invention can be employed to analyze the photo image with the face image or the photo image without the face image. Under this circumstance, the representative thumbnail can be selected by following the user's preferences.

From the above description, the present invention provides an automatic thumbnail selecting method and an automatic thumbnail selecting system for automatically selecting a representative thumbnail of a photo folder. According to the user's preferences about the photo images, a standard of the rating items may be set. Consequently, the selected representative thumbnail is very close to the preferences or the ideas of the user. Under this circumstance, since the user does not need to personally view and sieve all photo images of the photo folder, the automatic thumbnail selecting method and the automatic thumbnail selecting system of the present invention are time-saving and labor-saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic thumbnail selecting method for automatically selecting a representative thumbnail of a photo folder, said automatic thumbnail selecting method comprising steps of:
performing a face detecting step for judging whether there is at least one face image contained in plural photo images of said photo folder;
if said at least one face image in said plural photo images is detected by said face detecting step, performing a face recognizing step, which comprises sub-steps of:
performing a face recognizing operation on said plural photo images, thereby acquiring at least one facial feature;
calculating an occurrence number of said at least one facial feature in said plural photo images, and selecting said facial feature having the highest occurrence number as a target facial feature;
rating said plural photo images including said target facial feature, thereby acquiring plural scores; and
comparing said plural scores with each other to acquire a highest score;
if no face image in said plural photo images is detected by said face detecting step, performing a complexity analyzing step, which comprises sub-steps of:
performing a complexity analyzing operation on said plural photo images, thereby acquiring plural complexity values; and
comparing said plural complexity values with each other to acquire the highest complexity value; and
performing a selecting step for selecting said photo image with the highest score as said representative thumbnail of said photo folder after said face detecting step is performed, or selecting said photo image with the highest complexity value as said representative thumbnail of said photo folder after said complexity analyzing step is performed.

2. The automatic thumbnail selecting method according to claim 1, wherein said selecting step further comprises sub-steps of:
capturing said face image contained in said photo image with said highest score; and
assigning said captured face image as said representative thumbnail of said photo folder.

3. The automatic thumbnail selecting method according to claim 2, wherein if said photo image with said highest score contains a first face image and a second face image, said automatic thumbnail selecting method further comprises steps of:
comparing whether said target facial feature matches said facial feature corresponding to said first face image or said facial feature corresponding to said second face image; and
assigning said first face image or said second face image matching said target facial feature as said representative thumbnail of said photo folder.

4. The automatic thumbnail selecting method according to claim 1, wherein said selecting step further comprises sub-steps of:
capturing a middle zone contained in said photo image with the highest complexity value as a middle zone image; and
assigning said middle zone image as said representative thumbnail of said photo folder.

5. The automatic thumbnail selecting method according to claim 1, wherein said plural photo images are rated according to plural rating items, wherein said plural rating items include a facial organ item, a facial skin color item, a facial angle item, a facial size item, and a facial expression item.

6. The automatic thumbnail selecting method according to claim 5, wherein said score of said facial organ item is determined according to an organ number of said at least one facial feature and an organ shape completeness degree, said core of said facial skin color item is determined according to a tone of said at least one facial feature, said score of said facial angle item is determined according to a facial direction of said at least one facial feature, said score of said facial size item is determined according to a face size of said at least one facial feature in said at least one photo image, and said score of said facial expression item is determined by judging whether a mouse corner of said at least one facial feature is upturned or not.

7. The automatic thumbnail selecting method according to claim 1, wherein said complexity analyzing operation is performed to analyze entropy of each of said plural photo images.

8. An automatic thumbnail selecting system for automatically selecting a representative thumbnail of a photo folder, said automatic thumbnail selecting system being installed in a computer system with a storage unit and a controlling unit, said storage unit storing said photo folder and plural photo images, said controlling unit being in communication with said storage unit for selecting said representative thumbnail of said photo folder, said automatic thumbnail selecting system comprising:
a face detecting module in communication with said controlling unit for issuing a detecting signal to said controlling unit, wherein in response to said detecting signal, said controlling unit detects plural photo images contained in said photo folder, thereby acquiring at least one face image corresponding to said plural photo images;
an image analyzing module in communication with said controlling unit for issuing a recognizing signal or an analyzing signal to said controlling unit, wherein in response to said recognizing signal, said controlling unit recognizes said at least one face image, thereby acquiring at least one facial feature corresponding to said at least one face image, wherein in response to said analyzing signal, said controlling unit analyzes complexity of said plural photo images, thereby acquiring plural complexity values corresponding to said plural photo images;
a statistic module in communication with said controlling unit for issuing a statistic signal to said controlling unit, wherein in response to said statistic signal, said controlling unit calculates an occurrence number of said at least one facial feature in said plural photo images, and selects said facial feature having the highest occurrence number as a target facial feature; and
a rating module in communication with said controlling unit for issuing a first rating signal or a second rating signal to said controlling unit, wherein in response to said first rating signal, said controlling module rates said plural photo images including said target facial feature to acquire plural scores, compares said plural scores with each other to acquire a highest score of said plural scores, and assigns said photo image with the highest score as said representative thumbnail of said photo folder, wherein in response to said second rating signal, said controlling module compares said plural complexity values with each other to acquire the highest complexity value, and assigns said photo image with the highest complexity value as said representative thumbnail of said photo folder.

9. The automatic thumbnail selecting system according to claim 8, wherein when said controlling unit assigns the photo image with the highest score as said representative thumbnail of said photo folder, said image analyzing module issues a capturing signal to said controlling unit, wherein in response to said capturing signal, said controlling unit captures a face image contained in said photo image with said highest score, and assigns said captured face image as said representative thumbnail of said photo folder.

10. The automatic thumbnail selecting system according to claim 9, wherein if said photo image with said highest score contains a first face image and a second face image, said image analyzing module issues a comparing signal to said controlling unit, wherein in response to said comparing signal, said controlling unit compares whether said target facial feature matches said facial feature corresponding to said first face image or said facial feature corresponding to said second face image, and assigns said first face image or said second face image matching said target facial feature as said representative thumbnail of said photo folder.

11. The automatic thumbnail selecting system according to claim 8, wherein when said controlling unit assigns the photo image with the highest complexity value as said representative thumbnail of said photo folder, said image analyzing module issues a capturing signal to said controlling unit, wherein in response to said capturing signal, said controlling unit captures a middle zone contained in said photo image with the highest complexity value as a middle zone image, and assigns said middle zone image as said representative thumbnail of said photo folder.

12. The automatic thumbnail selecting system according to claim 8, wherein said rating module provides plural rating items, and said plural photo images including said target facial feature are rated by said controlling unit according to said plural rating items, wherein said plural rating items include a facial organ item, a facial skin color item, a facial angle item, a facial size item, and a facial expression item, wherein said plural rating items are set through a user operation interface.

13. The automatic thumbnail selecting system according to claim 12, wherein said score of said facial organ item is determined according to an organ number of said at least one facial feature and an organ shape completeness degree, said core of said facial skin color item is determined according to a tone of said at least one facial feature, said score of said facial angle item is determined according to a facial direction of said at least one facial feature, said score of said facial size item is determined according to a face size of said at least one facial feature in said at least one photo image, and said score of said facial expression item is determined by judging whether a mouse corner of said at least one facial feature is upturned or not.

14. The automatic thumbnail selecting system according to claim 8, wherein said computer system further comprises a display screen for displaying said photo folder, said plural photo images and said representative thumbnail, said storage unit is a hard disc, and said controlling unit is a central processing unit.

15. An automatic thumbnail selecting method for automatically selecting a representative thumbnail of a photo folder, said automatic thumbnail selecting method comprising steps of:
performing a face detecting step for detecting plural photo images in said photo folder, thereby acquiring at least one face image;
performing a face recognizing step, which comprises sub-steps of:
performing a face recognizing operation on said plural photo images, thereby acquiring at least one facial feature;
calculating an occurrence number of said at least one facial feature in said plural photo images, and selecting said facial feature having the highest occurrence number as a target facial feature;
rating said plural photo images including said target facial feature, thereby acquiring plural scores; and
comparing said plural scores with each other to acquire a highest score; and
performing a selecting step for selecting said photo image with the highest score as said representative thumbnail of said photo folder.

16. The automatic thumbnail selecting method according to claim 15, wherein said selecting step further comprises sub-steps of:
capturing said face image contained in said photo image with said highest score; and
assigning said captured face image as said representative thumbnail of said photo folder.

17. The automatic thumbnail selecting method according to claim 16, wherein if said photo image with said highest score contains a first face image and a second face image, said automatic thumbnail selecting method further comprises steps of:
comparing whether said target facial feature matches said facial feature corresponding to said first face image or said facial feature corresponding to said second face image; and
assigning said first face image or said second face image matching said target facial feature as said representative thumbnail of said photo folder.

18. The automatic thumbnail selecting method according to claim 15, wherein said plural photo images are rated according to plural rating items, wherein said plural rating items include a facial organ item, a facial skin color item, a facial angle item, a facial size item, and a facial expression item.

19. The automatic thumbnail selecting method according to claim 18, wherein said score of said facial organ item is determined according to an organ number of said at least one facial feature and an organ shape completeness degree, said core of said facial skin color item is determined according to a tone of said at least one facial feature, said score of said facial angle item is determined according to a facial direction of said at least one facial feature, said score of said facial size item is determined according to a face size of said at least one facial feature in said at least one photo image, and said score of said facial expression item is determined by judging whether a mouse corner of said at least one facial feature is upturned or not.

20. An automatic thumbnail selecting method for automatically selecting a representative thumbnail of a photo folder, said automatic thumbnail selecting method comprising steps of:
performing a face detecting step for detecting plural photo images in said photo folder, wherein no face image in said plural photo images is detected by said face detecting step;
performing a complexity analyzing step, which comprises sub-steps of:
performing a complexity analyzing operation on said plural photo images, thereby acquiring plural complexity values; and
comparing said plural complexity values with each other to acquire the highest complexity value; and
performing a selecting step for selecting said photo image with the highest complexity value as said representative thumbnail of said photo folder.

21. The automatic thumbnail selecting method according to claim 20, wherein said selecting step further comprises sub-steps of:
capturing a middle zone contained in said photo image with the highest complexity value as a middle zone image; and
assigning said middle zone image as said representative thumbnail of said photo folder.

22. The automatic thumbnail selecting method according to claim 20, wherein said complexity analyzing operation is performed to analyze entropy of each of said plural photo images.
